(19) United States
(12) Patent Application Publication
(10) Pub. No.: US 2025/0323321 A1
(43) Pub. Date: Oct. 16, 2025

(54) SOLVENT COMPOSITIONS FOR LITHIUM-METAL BATTERIES

(71) Applicant: Rutgers, The State University of New Jersey, New Brunswick, NJ (US)

(72) Inventors: Glenn G. Amatucci, Peapack, NJ (US); Rachael Behler, New Brunswick, NJ (US)

(21) Appl. No.: 19/170,531

(22) Filed: Apr. 4, 2025

Related U.S. Application Data
(63) Continuation of application No. PCT/US2023/076496, filed on Oct. 10, 2023.
(60) Provisional application No. 63/414,813, filed on Oct. 10, 2022.

(51) Int. Cl. H01M 10/0568; H01M 4/66; H01M 10/052

(52) U.S. Cl. CPC H01M 10/0568; H01M 4/661; H01M 10/052; H01M 2300/0034

(57) ABSTRACT

A battery includes a positive current collector; a positive electrode; an electrolyte; wherein the electrolyte comprises a solvent, wherein the solvent comprises at least one of fluorinated organosilicon and lithium metal; and a metal current collector, wherein the metal current collector comprises a lithium plated on the metal current collector, wherein a layer is coated over a lithium plated metal current collector, wherein the layer comprises at least nitrogen and fluorine.

### CROSS-REFERENCE TO RELATED APPLICATIONS

This application is a Continuation Application relating to and claiming the benefit of commonly-owned, co-pending PCT International Application No. PCT/US2023/076496, filed Oct. 10, 2023, which claims priority to and the benefit of U.S. Provisional Patent Application Ser. No. 63/414,813, filed Oct. 10, 2022, the content of each of the forgoing are herein incorporated by reference herein in their entirety.

### STATEMENT OF RIGHTS TO INVENTIONS MADE UNDER FEDERALLY SPONSORED RESEARCH

This invention was made with government support under grant number 83-1-490 awarded by the Department of Homeland Security, Science and Technology. The government has certain rights in the invention.

### FIELD OF INVENTION

The present disclosure relates generally to lithium-metal batteries. More specifically, the present disclosure relates to solvent compositions for lithium-metal batteries.

### BACKGROUND OF THE INVENTION

The development of viable Lithium-ion (Li-ion) battery technologies has sustained increased attention throughout the past decade. Such development is closely tied to the future of green technology and the reduction of high carbon emission energy use.

### SUMMARY OF THE INVENTION

The summary is a high-level overview of various aspects of the invention and introduces some of the concepts that are further detailed in the Detailed Description section below. This summary is not intended to identify key or essential features of the claimed subject matter, nor is it intended to be used in isolation to determine the scope of the claimed subject matter. The subject matter should be understood by reference to the appropriate portions of the entire specification, any or all drawings, and each claim.

Embodiments of the present disclosure relate to a battery including a positive current collector; a positive electrode; an electrolyte; where the electrolyte includes a solvent; where the solvent includes at least one of fluorinated organosilicon and lithium metal; and a metal current collector; where the metal current collector includes a lithium plated on the metal current collector; where a layer is coated over a lithium plated metal current collector; where the layer includes at least nitrogen and fluorine.

In some embodiments, the battery is a lithium metal battery.

In some embodiments, the battery is a metal battery comprising at least one of Si, Ge, AL, Ga, Bi, Ag, Sn or Au.

In some embodiments, the fluorinated organosilicon is fluoroethylene.

In some embodiments, the layer is less than 1000 nm thick.

In some embodiments, the layer is less than 500 nm thick.

In some embodiments, the layer includes silicon.

In some embodiments, a ratio of fluorinate to organosilicon in the fluorinated organo silicon is from 2:1 to 30:1.

In some embodiments, the solvent has a concentration is greater than 20% by volume of the electrolyte.

Embodiments of the present disclosure relate to a battery including a positive current collector; a positive electrode; an electrolyte; where the electrolyte comprises a solvent; where the solvent includes at least one of fluorinated organosilicon or lithium metal; a metal current collector; where the metal current collector consists essentially of no lithium metal.

In some embodiments, the battery is a lithium metal battery.

In some embodiments, the battery is a metal battery including at least one of Si, Ge, AL, Ga, Bi, Ag, Sn or Au.

In some embodiments, the fluorinated organosilicon is fluoroethylene.

In some embodiments, a ratio of fluorinate to organosilicon in the fluorinated organosilicon is 2:1 to 30:1.

In some embodiments, the solvent has a concentration is greater than 20% by volume of the electrolyte.

Embodiments of the present disclosure relate to a method of forming a lithium battery, including: obtaining a battery; where the battery includes: a positive current collector; a positive electrode; an electrolyte; where the electrolyte includes a solvent; where the solvent includes at least one of fluorinated organosilicon or lithium metal; and a metal current collector; where the metal current collector consists essentially of no lithium metal; applying a current in a range of 0.1 mAh/cm² to 20 mAh/cm²; and forming a coated lithium plating on the metal current collector; where the coated lithium plating includes a coating layer including at least nitrogen and fluorine.

In some embodiments, the fluorinated organosilicon is fluoroethylene.

In some embodiments, the layer is less than 1000 nm thick.

In some embodiments, the layer is less than 500 nm thick.

In some embodiments, the layer comprises silicon.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the present disclosure.

FIG. 1 shows a general organosilicon structure.

FIG. 2 is a schematic representation of a cross section of a Lithium-metal cell, according to embodiments of the present disclosure.

FIG. 3 is a schematic representation of a cross section of a Lithium-metal cell, according to embodiments of the present disclosure.

FIG. 4 is a schematic representation of a cross section of a Lithium-metal cell, according to embodiments of the present disclosure.

FIG. 5 is a schematic representation of a cross section of an anodeless coin cell, according to embodiments of the present disclosure.

FIG. 6 is a graph depicting a discharge capacity retention from cycle 1 using standard electrolyte composition 1M LiPF₆ EC/DMC and optimized solvent substituted compositions in anodeless cells at 4 mAh/cm², according to embodiments of the present disclosure.

FIG. 7 is a graph depicting a discharge capacity from cycle 1 using lithium slat substitutions in the optimized OS₃/FEC solvent in anodeless cells at 4 mAh/cm², according to embodiments of the present disclosure.

FIG. 8 is a graph depicting a discharge capacity retention from cycle 1 using optimized lithium salt system 0.6M LiTFSI 0.4M LDFOB with varied OS₃/FEC solvent ratio in anodeless cells at 4 mAh/cm².

FIG. 9 is a graph depicting a discharge capacity retention from cycle 1 using LiTFSI and LDFOB salt substitutions in the optimized OS₃/FEC solvent in anodeless cells at 4 mAh/cm².

FIG. 10 is a graph depicting a discharge capacity retention from cycle 1 using LiFSI salt substitutions in the optimized OS₃/FEC solvent in anodeless cells at 4 mAh/cm².

FIG. 11 is a graph depicting a discharge capacity retention from cycle 1 using optimized and benchmark electrolyte compositions in anodeless cells at lower plating capacity of 2.5 mAh/cm².

FIG. 12 is a graph depicting a discharge capacity retention from cycle 1 using optimized electrolyte compositions in anodeless cells at higher plating capacity of 6.5 mAh/cm².

### DETAILED DESCRIPTION

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. It will be understood that various changes may be made in the function and arrangement of elements without departing from the spirit and scope of the presently disclosed embodiments. Embodiment examples are described as follows with reference to the figures. Identical, similar, or identically acting elements in the various figures are identified with identical reference numbers and a repeated description of these elements is omitted in part to avoid redundancies.

Among those benefits and improvements that have been disclosed, other objects and advantages of this invention will become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention which are intended to be illustrative, and not restrictive.

Throughout the specification and claims, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.” Spatial or directional terms, such as “left”, “right”, “inner”, “outer”, “above”, “below”, and the like, are not to be considered as limiting as the invention can assume various alternative orientations. All numbers used in the specification are to be understood as being modified in all instances by the term “about”. The term “about” means a range of plus or minus ten percent of the stated value.

Unless otherwise indicated, all ranges or ratios disclosed herein are to be understood to encompass any and all subranges or sub-ratios subsumed therein. Unless otherwise indicated, all ranges or ratios herein are understood to be inclusive (i.e., to include both the minimum and maximum values of such ranges or ratios). For example, a stated range or ratio of “1 to 10” should be considered to include any and all subranges between (and inclusive of) the minimum value of 1 and the maximum value of 10; that is, all subranges or sub-ratios beginning with a minimum value of 1 or more and ending with a maximum value of 10 or less, such as but not limited to, 1 to 6.1, 3.5 to 7.8, and 5.5 to 10.

Currently, secondary Li-ion battery technology utilizing metal oxide and graphite electrode have fallen short in meeting growing power demands. Thus, efforts to enable high energy density materials, such as lithium-metal, are at the research forefront. Lithium-metal batteries are often regarded as the ultimate standard of achievable energy density, owing to the high theoretical capacity of lithium-metal (3,860 mAh/g), especially when paired with high energy density cathode materials. However, the realization of lithium-metal battery technology is met with practical drawbacks stemming from non-ideal lithium plating and dendrite formation, lithium-metal instability and volume changes experienced during cycling. These drawbacks manifest as serious safety concerns that inhibit the commercial viability of lithium-metal in secondary batteries and draw increased attention to the nuances of lithium plating and SEI formation in lithium-metal batteries.

Several enabling technologies have been investigated to address the shortcomings of lithium-metal batteries and realize lithium-metal enabled high volumetric energy density. Approaches include the use of nanoparticles in electrode material, novel lithium host structures, high conductivity solid electrolyte, and optimized liquid electrolytes. Many approaches focus on tuning the protective solid electrolyte interface (SEI), formed during the initial electrolyte reduction at the negative electrode, as an approach to enable lithium-metal technology. The SEI morphological structure and chemical composition are directly influenced by the chemistry of the electrolyte used in the system and thus influence cell performance and longevity.

Lithium salt and cyclic/linear carbonate-based electrolyte compositions (including lithium hexafluorophosphate salt in ethylene carbonate and dimethyl carbonate solvent, 1M LiPF₆ EC/DMC) are commonly used in commercial applications and may limit achievable capacity due to low thermal and chemical stability. Although this composition provides beneficial SEI components, by way of LiPF₆ hydrolysis, instabilities of LiPF₆ in carbonate solvents necessitate further electrolyte improvement. Imide-based salts lithium bis(trifluoromethanesulfonyl)imide (LiTFSI) and lithium bis(fluorosulfonyl)imide (LiFSI) serve as promising candidates for electrolyte optimization given their more favorable kinetics, improved chemical and thermal stabilities and known contributions to SEI stability through LiF formation. Additionally, LDFOB is also a potential candidate for electrolyte improvement efforts, due to its unique contribution of oxalate reduction products to the SEI. When paired with fluorinated solvents, such as fluoroethylene carbonate (FEC) and fluororganosiyl-based solvents (“OS₃”, Silatronix) additional fluorinated components may be made available to the SEI architecture, enabling higher efficiency and cycle lifetime. These fluororganosiyl-based solvents were initially developed to preserve the positive electrode interface, by way of delaying LiPF₆ decomposition and subsequent HF formation. As of yet, these compounds have not been investigated as solvents for use in lithium-metal battery electrolytes. Due to the unique features of this compound, including functional Si/F groups and an unstable nitrile backbone, incorporation into electrolyte compositions may reveal unique pathways for lithium plating chemistries. Downstream chemistries may allow for the formation of LixSi catalyst species to from, facilitated by the facile breakdown of an unstable nitrile backbone. If formed, these catalyst species would allow for favorable lithium-metal (Li-metal) nucleation and stable deposition. This reaction mechanism may elucidate future modifications of similar catalyzing chemistries, thus enabling a host of electrochemical techniques for the improvement of lithium deposition through electrolyte optimization.

In some embodiments, the present specification relates to novel liquid electrolytes that enable secondary Li-metal batteries as well as in-situ formed anodeless Li-metal batteries. In some embodiments, by applying low-capacity lithium plating (LCP), the initial formation of the SEI is magnified to observe first cycle coulombic efficiency. This observation cannot be made when applying larger plating capacities, where the effects on dendrite formation are more easily seen. Utilizing electrochemical methods that directly probe and segregate solid electrolyte layer (SEI) formation from dendritic capacity fade, in some embodiments, the present disclosure describes enabling contributions of optimized electrolyte to cycling efficiency and lifetime.

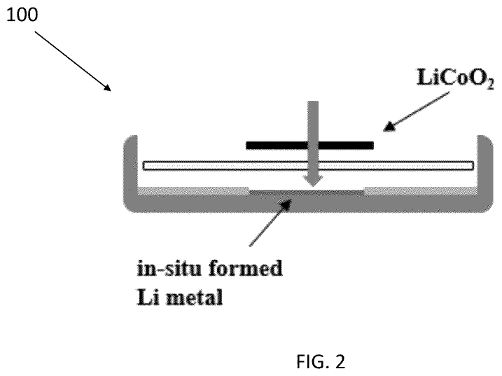

In some embodiments, the present disclosure relates to a battery. In some embodiments, the battery is a metal battery. In some embodiments, the metal may include Si, Ge, Al, Ga, Bi, Ag, SN or Au. In some embodiments, the present disclosure relates lithium-ion metal batteries. As depicted in FIG. 2, in some embodiments, the present disclosure relates to a lithium-ion metal battery 100 after in-situ production during charging of a battery. In some embodiments the lithium-ion battery includes a positive current collector, a positive electrode, an electrolyte and a metal current collector.

In some embodiments, the electrolyte includes a solvent. In some embodiments, the present disclosure relates to a solvent molecule of a lithium-ion battery. In some embodiments, the solvent includes a cation, a nitrile and a fluorine. In some embodiments, the cation is a metal cation. In some embodiments, the metal is a metal that is known to alloy with lithium. In some embodiments, the metal is Ge, Al, Ga, Bi, Ag, Sn, Au or Si. In some embodiments, the cation is a silicon cation.

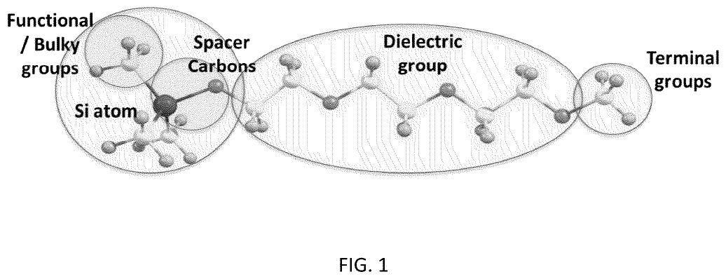

In some embodiments, the solvent includes a fluorinated organosilicon. FIG. 1 depicts a general structure of an organosilicon. In some embodiments, the fluorinated organosilicon is fluoroethylene (FEC). In some embodiments, the solvent includes a lithium metal.

In some embodiments, the ratio of fluorinate to organosilicon is from 2:1 to 30:1. In some embodiments, the ratio of fluorinate to organosilicon is from 5:1 to 30:1. In some embodiments, the ration is from 10:1 to 30:1. In some embodiments, the ration is from 15:1 to 30:1. In some embodiments, the ration is from 20:1 to 30:1. In some embodiments, the ration is from 25:1 to 30:1.

In some embodiments, the ratio of fluorinate to organosilicon is from 2:1 to 25:1. In some embodiments, the ration is from 2:1 to 20:1. In some embodiments, the ratio of fluorinate to organosilicon is from 2:1 to 15:1. In some embodiments, the ration is from 2:1 to 10:1. In some embodiments, the ration is from 2:1 to 5:1.

In some embodiments, the ratio of fluorinate to organosilicon is from 4:1 to 20:1. In some embodiments, the ration is from 12:1 to 25:1. In some embodiments, the ratio of fluorinate to organosilicon is from 5:1 to 15:1. In some embodiments, the ration is from 10:1 to 25:1. In some embodiments, the ration is from 10:1 to 20:1.

In some embodiments, the solvent has a volume concentration of greater than 20% by volume of the electrolyte. In some embodiments, the solvent has a volume concentration of 20% to 99% by volume of the electrolyte. In some embodiments, the volume concentration is 30% to 99% by volume of the electrolyte. In some embodiments, the volume concentration is 40% to 50% by volume of the electrolyte. In some embodiments, the volume concentration is 50% to 99% by volume of the electrolyte. In some embodiments, the volume concentration is 60% to 99% by volume of the electrolyte. In some embodiments, the volume concentration is 70% to 99% by volume of the electrolyte. In some embodiments, the volume concentration is 80% to 99% by volume of the electrolyte. In some embodiments, the volume concentration is 90% to 99% by volume of the electrolyte.

In some embodiments, the solvent has a volume concentration of 20% to 99% by volume of the electrolyte. In some embodiments, the volume concentration is 20% to 90% by volume of the electrolyte. In some embodiments, the volume concentration is 20% to 80% by volume of the electrolyte. In some embodiments, the volume concentration is 20% to 70% by volume of the electrolyte. In some embodiments, the volume concentration is 20% to 60% by volume of the electrolyte. In some embodiments, the volume concentration is 20% to 50% by volume of the electrolyte. In some embodiments, the volume concentration is 20% to 40% by volume of the electrolyte. In some embodiments, the volume concentration is 20% to 30% by volume of the electrolyte.

In some embodiments, the solvent has a volume concentration of 30% to 90% by volume of the total mixture. In some embodiments, the volume concentration is 40% to 80% by volume of the electrolyte. In some embodiments, the volume concentration is 20% to 80% by volume of the electrolyte. In some embodiments, the volume concentration is 50% to 70% by volume of the electrolyte. In some embodiments, the volume concentration is 60% to 80% by volume of the electrolyte. In some embodiments, the volume concentration is 30% to 50% by volume of the electrolyte. In some embodiments, the volume concentration is 40% to 60% by volume of the electrolyte. In some embodiments, the volume concentration is 30% to 60% by volume of the electrolyte.

In some embodiments, the lithium is deposited on a substrate using a low areal capacity plating technique.

In some embodiments, the solvent includes a fluororganosiyl-based solvent (OS₃). In some embodiments, OS₃ solvent includes FEC. In some embodiments, the ratio of OS₃ to FEC is 90/10.

In some embodiments, the solvent includes 0.6 M LiTFSI to 2 M LiTFSI. In some embodiments, the solvent includes 1 M LiTFSI to 2 M LiTFSI. In some embodiments, the solvent includes 1.5 M LiTFSI to 2 M LiTFSI. In some embodiments, the solvent includes 0.6 M LiTFSI to 1.5 M LiTFSI. In some embodiments, the solvent includes 0.6 M LiTFSI to 1 M LiTFSI. In some embodiments, the solvent includes 1 M LiTFSI to 1.5 M LiTFSI. In some embodiments, the solvent includes 0.8 M LiTFSI to 1.2 M LiTFSI. In some embodiments, the solvent includes 1.5 M LiTFSI to 1.8 M LiTFSI. In some embodiments, the solvent includes 1 M LiTFSI to 1.2 M LiTFSI.

In some embodiments, the metal current collector includes lithium plated on the metal current collector. In some embodiments, a layer is coated over the lithium plated metal current collector. In some embodiments, the layer includes at least one of nitrogen or fluorine. In some embodiments, the layer includes silicon. In some embodiments, the lithium plated on the metal current collector is results in improved charge/discharge efficiencies in the battery, as well as longer cycle life before battery cell failure.

In some embodiments, the layer is less than 5000 nm thick. In some embodiments, the layer is less than 1000 nm thick. In some embodiments, the layer is less than 500 nm thick.

In some embodiments, the battery has an areal capacity of 0.1 mAh/cm² to 3 mAH/cm². In some embodiments, the battery has an areal capacity of 0.5 mAh/cm² to 3 mAH/cm². In some embodiments, the battery has an areal capacity of 1 mAh/cm² to 3 mAH/cm². In some embodiments, the battery has an areal capacity of 1.5 mAh/cm² to 3 mAH/cm². In some embodiments, the battery has an areal capacity of 2 mAh/cm² to 3 mAH/cm². In some embodiments, the battery has an areal capacity of 2.5 mAh/cm² to 3 mAH/cm².

In some embodiments, the battery has an areal capacity of 0.5 mAh/cm² to 2.5 mAH/cm². In some embodiments, the battery has an areal capacity of 0.5 mAh/cm² to 2 mAH/cm². In some embodiments, the battery has an areal capacity of 0.5 mAh/cm² to 1.5 mAH/cm². In some embodiments, the battery has an areal capacity of 0.5 mAh/cm² to 1 mAH/cm².

In some embodiments, the battery has an areal capacity of 1.5 mAh/cm² to 2.5 mAH/cm². In some embodiments, the battery has an areal capacity of 1.5 mAh/cm² to 2 mAH/cm². In some embodiments, the battery has an areal capacity of 2 mAh/cm² to 2.5 mAH/cm². In some embodiments, the battery has an areal capacity of 1 mAh/cm² to 2.5 mAH/cm².

In some embodiments, the battery is a coin cell battery. In some embodiments, the battery is an anodeless coin cell battery.

In some embodiments, a low areal plating technique is used to deposit the lithium

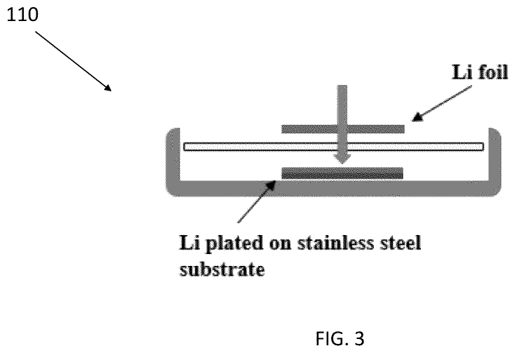

In some embodiments, the present disclosure relates to a metal battery that may be sold by a manufacturer (i.e., prior to in-situ production). In some embodiments, the metal may include Si, Ge, Al, Ga, Bi, Ag, SN or Au. As depicted in FIG. 3, in some embodiments, the present disclosure relates to a lithium-ion metal battery 110 prior to in-situ production. In some embodiments, the battery includes a positive current collector, a positive electrode, an electrolyte and a metal current collector.

In some embodiments, the electrolyte includes a solvent. In some embodiments, the present disclosure relates to a solvent molecule of a lithium-ion battery. In some embodiments, the solvent includes a cation, a nitrile and a fluorine. In some embodiments, the cation is a metal cation. In some embodiments, the metal is a metal that is known to alloy with lithium. In some embodiments, the metal is Ge, Al, Ga, Bi, Ag, Sn, Au or Si. In some embodiments, the cation is a silicon cation.

In some embodiments, the solvent includes a fluorinated organosilicon. In some embodiments, the fluorinated organosilicon is fluoroethylene (FEC). In some embodiments, the solvent includes a lithium metal. In some embodiments, the solvent includes the same characteristics as the solvent described above.

In some embodiments, the metal current collector consists essentially of no lithium metal. In some embodiments, the metal current collector does not include lithium metal or any equivalent thereof.

In some embodiments, the present disclosure relates to a method of forming a battery. In some embodiments, the method includes obtaining a battery. In some embodiments, the battery is a metal battery. In some embodiments, the metal may include Si, Ge, Al, Ga, Bi, Ag, SN or Au. In some embodiments, the present disclosure relates lithium-ion metal batteries. In some embodiments, the battery includes a positive current collector, a positive electrode, an electrolyte and a metal current collector, as described above.

In some embodiments, once the battery is obtained, the method includes applying a current to the battery. In some embodiments, the current is in the range of 0.1 mAh/cm² to 20 mAh/cm². In some embodiments, the current is in the range of 0.5 mAh/cm² to 20 mAh/cm². In some embodiments, the current is in the range of 1 mAh/cm² to 20 mAh/cm². In some embodiments, the current is in the range of 2 mAh/cm² to 20 mAh/cm². In some embodiments, the current is in the range of 5 mAh/cm² to 20 mAh/cm². In some embodiments, the current is in the range of 10 mAh/cm² to 20 mAh/cm². In some embodiments, the current is in the range of 15 mAh/cm² to 20 mAh/cm².

In some embodiments, the current is in the range of 0.1 mAh/cm² to 15 mAh/cm². In some embodiments, the current is in the range of 0.1 mAh/cm² to 10 mAh/cm². In some embodiments, the current is in the range of 0.1 mAh/cm² to 5 mAh/cm². In some embodiments, the current is in the range of 0.1 mAh/cm² to 2 mAh/cm². In some embodiments, the current is in the range of 0.1 mAh/cm² to 1 mAh/cm². In some embodiments, the current is in the range of 0.1 mAh/cm² to 0.5 mAh/cm².

In some embodiments, the current is in the range of 0.5 mAh/cm² to 2 mAh/cm². In some embodiments, the current is in the range of 1 mAh/cm² to 10 mAh/cm². In some embodiments, the current is in the range of 2 mAh/cm² to 5 mAh/cm². In some embodiments, the current is in the range of 2 mAh/cm² to 10 mAh/cm². In some embodiments, the current is in the range of 10 mAh/cm² to 15 mAh/cm². In some embodiments, the current is in the range of 0.5 mAh/cm² to 1 mAh/cm². In some embodiments, the current is in the range of 5 mAh/cm² to 10 mAh/cm².

In some embodiments, the method includes forming a coated lithium plate on the metal current collector. In some embodiments, a coating of the coated lithium plate includes at least nitrogen and fluorine. In some embodiments, the lithium plated on the metal current collector is results in improved charge/discharge efficiencies in the battery, as well as longer cycle life before battery cell failure.

### EXAMPLES

### Example 1: Electrode Preparation/Coin Cell Assembly

Lithium cobalt (III) oxide (LCO) electrodes were prepared using 80 wt % LiCoO₂, 8 wt % carbon, and 12 wt % polymer binder. The electrode disks were dried overnight at 120 C.° under vacuum. Coin cells were prepared under argon with less than 0.1 ppm oxygen and water content. A double layer Whatman glass fiber separator was whetted using 150 μl electrolyte dispensed using a 0-100 μl Thermofisher Finnpipette. Electrolyte compositions were prepared under argon and mixed overnight at 850 RPM. The anodeless coin cell plating area was restricted to 0.6 cm² using a 5 mil Kapton ring in a scratched coin cell base. Lithium-metal cells were prepared similarly, using 1.27 cm², 300 μm lithium disks and 10 mil, 1.19 cm² scratched stainless steel (SS316) disk in the coin cell base.

Electrochemical testing was conducted using a Bio-Logic galvano/potentiostat. Anodeless coin cell experiments were conducted using an applied areal current of 0.3 mA/cm² to 4.2V, followed by constant voltage to 0.15 mA/cm² and discharge areal current of 0.2 mA/cm² to 2.75V. Cycle charge and discharge capacity was used to evaluate coulombic efficiency and discharge capacity retention for tested electrolyte compositions. Lithium plating experiments were conducted using a charge and discharge areal current of 0.08 mA/cm² limited by 0.5V or one hour. Couombic efficiency data was analyzed for the tested electrolyte compositions to evaluate SEI formation. Both experiments were preceded by a one-hour rest period at open circuit voltage.

In some embodiments, low areal capacity plating technique (LCP) enables direct and amplified observation of the SEI through coulombic efficiency measurements. Here, LCP is applied within a lithium-metal cell configuration, where lithium is deposited on a stainless-steel substrate. FIG. 2 depicts a Li-metal cell 100 according to embodiments of the present disclosure. Specifically, the depicted Li-metal cell 100 includes a stainless steel spacer 102, a Li-metal 104, a glass fiber separator 106 and a stainless-steel substrate 108. In some embodiments, as depicted in FIG. 2, the Li-metal 104 is deposited on the stainless-steel substrate 108. In some embodiments, the glass fiber separator 106 separates the stainless-steel substrate 108 and the Li-metal 104. Using this technique, specific contributions to the SEI can be evaluated.

### Example 2: Evaluation of Common Salts and Novel Additives

Common commercial electrolyte compositions such as LiPF₆ salts dissolved in cyclic and linear carbonates such as EC/DMC/EMC may be limiting for Li-battery applications due to its poor thermal and chemical stability especially when utilized for next generation Li metal cells. Modifications were made to optimize electrolyte solutions in Li-metal half cells in order investigate the influence on formed SEI using ultra low plating capacity.

The initial electrolyte composition used was 1M LiPF₆ EC/DMC. Maintaining lithium concentration and solvent composition, LiPF₆ was substituted for LiTFSI due to its known beneficial contribution of LiF, morphological benefits to the SEI, and favorable charge transfer kinetics. Table 1 depicts the Coulombic efficiency (CE) measurements of standard baseline and benchmark electrolyte compositions evaluated at 0.08 mAh/cm² in Li-metal half cells. Salt concentrations and solvent volumetric ratios are given. Coulombic efficiencies for cycles 1, 10, 20, 50, 100 and 200 are shown. As depicted in Table 1, LiPF₆ yielded poor first cycle efficiency of 47.3% (vs 58.8% for 1M LiPF₆ EC/DMC). However, with the addition of FEC, first cycle efficiency is improved to 81.11% and exceeds that of the commercial baseline composition (1M LiPF₆ EC/DMC).

TABLE 1

| | CE- | CE- | CE- | CE- | CE- | CE- |
|---|---|---|---|---|---|---|
| Electrolyte | 1 | 10 | 20 | 50 | 100 | 200 |
| 1M LiPF₆EC/DMC | 58.8 | 85.68 | 73.02 | 76.27 | 60.96 | 64.84 |
| 1M LiTFSI EC/DMC | 47.3 | 83.51 | 80.78 | 73.22 | 77.5 | 100 |
| 1M LITFSI 90/10 | 81.11 | 84.89 | 84.48 | 78.67 | 64.36 | 88.28 |
| EC-DMC/FEC | | | | | | |

Additionally, alkali metal additives (CsPF₆ and KPF₆) were also included to establish a baseline of performance. CsPF₆ and KPF₆ were each added in the amounts of 0.05M, 0.15M to standard electrolyte 1M LiPF₆ EC/DMC and tested for coulombic efficiency. Table 2 depicts coulombic efficiency measurements of the novel additive electrolyte compositions evaluated at 0.08 mAh/cm2 in Li-metal half cells. Coulombic efficiencies for cycles 1, 10, 20, 50, 100 and 200 are shown. All solvent components of listed electrolyte compositions are given in terms of volumetric ratio except where molar ratio is indicated by *.

TABLE 2

| | CE- | CE- | CE- | CE- | CE- | CE- |
|---|---|---|---|---|---|---|
| Electrolyte | 1 | 10 | 20 | 50 | 100 | 200 |
| 1M LiPF₆EC/DMC | 58.8 | 85.68 | 73.02 | 76.27 | 60.96 | 64.84 |
| 1M LiPF₆ 0.05M | 51.99 | 83.41 | 67.56 | 77.49 | 100 | 82.29 |
| KPF₆ EC/DMC | | | | | | |
| 1M LiPF₆ 0.15M | 50.42 | 81.79 | 60.31 | 50.76 | 100 | 100 |
| KPF₆ EC/DMC | | | | | | |
| 1M LiPF₆ 0.05M | 48.65 | 82.94 | 68.37 | 73.01 | 54.5 | 100 |
| KCₛPF₆ EC/DMC | | | | | | |
| 1M LiPF₆ ₁.05M | 49.29 | 82.09 | 73.25 | 66.5 | 77.64 | 62.84 |
| CₛPF₆ EC/DMC | | | | | | |
| 1.2M LiTFSI (1/2 | 44.74 | 76.57 | 82.88 | 76.06 | 75.03 | 100 |
| TEP/BTFE) | | | | | | |
| 1.2M LiTFSI (1/2 | 43.78 | 79.02 | 84.99 | 80.06 | 79.13 | 100 |
| DMC/BTFE)* | | | | | | |

As depicted in Table 2, first cycle loss and subsequent cycling stability were not improved for the small capacities utilized here to magnify SEI contributions.

Additional novel electrolyte formulations were also investigated, including those reported to enable favorable lithium deposition morphology under higher plating capacities. Specifically, ether-based composition, 1.2M LiTFSI BTFE/TEP (1/2 molar ratio), showed no improvement in first cycle efficiencies compared to that of the compositions depicted in Tables 1 and 2.

### Example 3: Incorporation of Novel OS₃ Solvent

Solvent modifications, beyond the addition of an FEC additive, were made to incorporate additional fluorine components, in an effort to enhance the formation of LiF on the lithium-metal interface. The fluororganosiyl based solvent (OS₃) was utilized in place of DEC for this purpose. Using the 1M LiTFSI salt shown to be beneficial in the 90/10 EC-DMC/FEC system of Table 1, OS₃ was substituted in place of EC/DM. Table 3 depicts the coulombic efficiency measurements of electrolyte compositions optimized for favorable SEI formation evaluated at 0.08 mAh/cm² in Li-metal half cells. Coulombic efficiency for cycles 1, 10, 20, 50, 100 and 200 are shown.

TABLE 3

| | CE- | CE- | CE- | CE- | CE- | CE- |
|---|---|---|---|---|---|---|
| Electrolyte | 1 | 10 | 20 | 50 | 100 | 200 |
| 1M LiPF₆ EC/DMC | 58.8 | 85.68 | 73.02 | 76.27 | 60.96 | 64.84 |
| 1M LiTFSI 90/10 | 81.11 | 84.89 | 84.48 | 78.67 | 64.36 | 88.28 |
| EC-DMC/FEC | | | | | | |
| 1M LiTFSI 90/10 | 83.47 | 74.95 | 77.76 | 92.97 | 88.51 | 75.69 |
| OS3/FEC | | | | | | |
| 1M LiTFSI 90/10 | 33.13 | 85.78 | 85.28 | 83.28 | 100 | 94.49 |
| MOPN/FEC | | | | | | |
| 1M LiBF₄ 90/10 | 64.22 | 53.31 | 55.83 | 65.01 | 66.38 | 70.63 |
| OS3/FEC | | | | | | |
| 1M LiPF₆ 90/10 | 79.97 | 72.67 | 73.47 | 76.27 | 97.29 | 100 |
| OS3/FEC | | | | | | |
| 2M LiTFSI 90/10 | 82.09 | 74.52 | 78.42 | 89.44 | 82.27 | 95.35 |
| OS3/FEC | | | | | | |

As depicted in Table 3, using OS₃ yielded moderate benefits in first cycle loss and subsequent cycle efficiency, significantly improving upon standard electrolyte performance. To further probe the benefit of OS₃ solvent substitution, high charge transferring enabling salts LiB4 and LiPF₆ were substituted for LiTFSI. While both substitutions showed improvements over the standard electrolyte, neither approached the performance of the 1M LiTFSI composition.

Additional improvements to the 1M LiTFSI 90/10 OS₃/FEC composition were also attempted, utilizing 3-methoxypropionitrile (3-MPN) place of OS₃ and a higher LiTFSI salt content. Substituting 3-MPN for OS₃ did not improve first cycle loss, however efficiency was improved to a small degree in later cycles, as depicted in Table 3. Using a higher LiTFSI salt concentration salt (2M LiTFSI vs 1M LiTFSI), no significant effect on first cycle loss and cycling stability was observed, as depicted in Table 3. The influence of the high molar lithium salt concentrations has been investigated for cycle efficiency at higher capacities, however not for the contribution to SEI formation in such an amplified LCP experimental set up as this.

### Example 4: OS₃/FEC Based Electrolytes Incorporating LDFOB

A composition using LiBF₄ and LDFOB salts in a 2/1 DEC/FEC was investigated using ultra low plating capacities. Table 4 depicts coulombic efficiency measurements of electrolyte compositions incorporating OS₃/FEC solvent and LDFOB salt evaluated at 0.08 mAh/cm² in Li-metal half cells. Coulombic efficiency for cycles 1, 10, 20, 50, 100 and 200 are shown.

TABLE 4

| | CE- | CE- | CE- | CE- | CE- | CE- |
|---|---|---|---|---|---|---|
| Electrolyte | 1 | 10 | 20 | 50 | 100 | 200 |
| 1M LiPF₄ 2/1 DEC/FEC | 75.6 | 79.87 | 65.53 | 70.19 | 71.99 | 75.25 |
| 0.6M LiPF₄ 0.4M | 70.75 | 87.46 | 91.44 | 95.71 | 94.6 | 83.11 |
| LDFOB 2/1 DEC/FEC | | | | | | |
| 0.6M LiPF₄ 0.6M | 67.06 | 83.99 | 87.98 | 91.99 | 92.57 | 88.18 |
| LDFOB 2/1 DEC/FEC | | | | | | |
| 0.6M LiPF₄ 0.4M | 77.67 | 89.23 | 90.56 | 93.47 | 92.14 | 100 |
| LDFOB 2/1 OS3/FEC | | | | | | |
| 0.6M LiPF₄ 0.6M | 82.09 | 85.86 | 90.53 | 91.66 | 92.77 | 90.37 |
| LDFOB 90/10 OS3/FEC | | | | | | |
| 0.6M LiPF₄ 0.4M | 74.62 | 81.58 | 80.99 | 85.9 | 89.76 | 100 |
| LDFOB 90/10 OS3/FEC | | | | | | |
| 0.6M LiTFSI 0.4M | 85.28 | 90.63 | 95.78 | 97.47 | 96.9 | 96.23 |
| LDFOB 90/10 OS3/FEC | | | | | | |
| 1M LiTFSI 0.4M | 84.74 | 91.15 | 95.63 | 96.57 | 97.51 | 97.66 |
| LDFOB 90/10 OS3/FEC | | | | | | |
| 0.6M LiFSI 0.4M | 82.14 | 89.92 | 94.85 | 97.39 | 96.49 | 96.71 |
| LDFOB 90/10 OS3/FEC | | | | | | |

Direct solvent substitution from DEC and FEC to the OS₃ and FEC system in the 0.6M LiBF₄ 0.6M LDFOB 2/1 DEC/FEC composition yielded higher first cycle efficiency, improving from 67.06% to 82.09%, as depicted in Table 4. This composition was further improved by substituting LiBF₄ for LiTFSI, decreasing the LDFOB concentration, and increasing the relative content of OS₃ (0.6M LiTFSI 0.4M LDFOB 90/10 OS₃/FEC), as depicted in Table 4. Increasing the LiTFSI concentration further to 1M slightly diminished first cycle loss but preserves cycling stability, as depicted in Table 4. Substituting LiTFSI for LiFSI within the composition did not yield a significant change in performance, where first cycle loss and later cycling efficiencies are only slightly diminished. Thus, a beneficial interaction between the LiTFSI/LDFOB salt system in OS₃/FEC solvent was determined.

### Example 5: Impact of OS₃ to FEC Ratio in LiTFSI/LDFOB Salt System

Within the LiTFSI/LDFOB OS₃/FEC system established in the previous round, the ratio of OS₃ and FEC solvent components was varied to understand their interaction. Alone, FEC is not stable with Li-metal, but plays an important enabling role in stabilizing a solvent against continuous unwanted decomposition. While decomposition of the fluororganosiyl compound allows for the incorporation of Si and F into the SEI, continuous decomposition would be detrimental to plating efficiencies. Table 5 depicts the coulombic efficiency measurements of r electrolyte compositions incorporating OS₃/FEC solvent in LiTFSI/LDFOB salt systems evaluated at 0.08 mAh/cm² in Li-metal half cells. Coulombic efficiency for cycles 1, 10, 20, 50, 100 and 200 are shown.

TABLE 5

| | CE- | CE- | CE- | CE- | CE- | CE- |
|---|---|---|---|---|---|---|
| Electrolyte | 1 | 10 | 20 | 50 | 100 | 200 |
| 1M LiTFSI EC/DMC | 47.3 | 83.51 | 80.78 | 73.22 | 77.5 | 100 |
| 1M LiTFSI 90/10 | 83.47 | 74.95 | 77.76 | 92.97 | 88.51 | 75.69 |
| OS3/FEC | | | | | | |
| 0.6M LiTFSI 0.4M | 85.28 | 90.63 | 95.78 | 97.47 | 96.9 | 96.23 |
| LDFOB 90/10 OS3/FEC | | | | | | |
| 0.6M LiTFSI 0.4M | 85.37 | 94.03 | 96.89 | 97.17 | 96.68 | 95.89 |
| LDFOB 50/50 OS3/FEC | | | | | | |
| 0.6M LiTFSI 0.4M | 85.32 | 93.58 | 97.39 | 98.68 | 96.56 | 93.16 |
| LDFOB 10/90 OS3/FEC | | | | | | |
| 1M LiTFSI 90/10 EC- | 81.11 | 84.89 | 84.48 | 78.67 | 64.36 | 88.28 |
| DMC/FEC | | | | | | |
| 2M LiTFSI 90/10 | 82.09 | 74.52 | 78.42 | 89.44 | 82.27 | 95.35 |
| OS3/FEC | | | | | | |

As depicted in Table 5, within the LiTFSI/LDFOB salt system, increasing the FEC content from 50/50 to 90/10 slightly improves first cycle efficiencies. Here, the effect of FEC is robust within a wide range. As the benefits of OS₃/FEC to the 1M LITFSI system have already been shown (included again in this table for comparison), it is evident that LDFOB and FEC enable the performance of the OS₃/FEC solvent composition.

### Example 6: Transition to Dendritic Capacity Fade Observation: Cell Configuration Optimization

Increasing the areal capacity from 0.1 to 1 and finally 3 mAh/cm² (consistent with the areal capacity of a commercial Li-ion battery) yields a systematic increase in the first cycle plating efficiencies. Table 6 depicts coulombic efficiency measurements of Li-metal cell configurations featuring stainless steel and copper substrates evaluated at indicated areal capacities, utilizing electrolyte composition 0.6M LiTFSI 0.4M LDFOB 90/10 OS₃/FEC. Coulombic efficiency for cycles 1, 10, 20, 50, 100 and 200 are shown.

TABLE 6

| | CE- | CE- | CE- | CE- | CE- | CE- |
|---|---|---|---|---|---|---|
| Electrolyte | 1 | 10 | 20 | 50 | 100 | 200 |
| 0.1 mAh/cm² | 89.77 | 87.81 | 96.2 | 96.49 | 96.14 | 96.04 |
| stainless-steel | | | | | | |
| 1 mAh/cm² | 95.74 | 97.97 | 97.62 | 98.27 | 97.96 | 98.6 |
| stainless-steel | | | | | | |
| 3 mAh/cm² | 97.69 | 98.15 | 97.34 | 97.65 | 100 | 100 |
| stainless-steel | | | | | | |
| 3 mAh/cm² | 97.56 | 98.91 | 99.07 | 100 | 100 | 100 |
| copper | | | | | | |
| 0.08 mAh/cm² (LCP) | 85.28 | 90.63 | 95.78 | 97.47 | 96.9 | 96.23 |
| stainless-steel | | | | | | |

Specifically, the areal capacity moved from 90% at 0.1 mAh/cm², to 96% at 1 mAh/cm², and 98% at 3 mAh/cm². This trend illustrates the effectiveness of the low areal capacity plating studies as an effective tool to isolate the initial formation of SEI from advanced stage lithium deposition. Later stage lithium deposition may interact differently with electrolyte chemistry, and thus cloud any initial SEI contributing interactions that may have occurred. Additionally, later stage lithium deposition features morphologies unlike those occurring during initial deposition. In applying the LCP technique, the capacity losses associated with these phenomena were segregated.

As shown, the use of low plating capacities such as 0.08 mAh/cm² allows for the assessment of the formed SEI, where at higher capacities the effect of the SEI formation is not clearly seen.

In the next section we transition these Li-metal current collector configurations to LiCoO₂ current collector anodeless designs to assess dendritic capacity fade of optimized electrolyte compositions at higher plating capacities.

### Example 7: Dendritic Capacity Fade Observation in Anodeless Cells

Based on SEI efficiency studies in the Li-metal cell setup, promising electrolytes were further investigated in an anodeless cell configuration, where a Lithium cobalt oxide cathode (LiCoO₂) cathode is used and lithium plating occurs directly on the stainless-steel coin cell base. FIG. 3 depicts an anodeless coin cell 110 with a configuration used in higher capacity plating analysis of dendritic capacity fade. As depicted in FIG. 3, the anodeless coin cell 110 includes a stainless-steel spacer 112, an LCO 114, a glass fiber separator 116 and a Kapton ring 118. Lithium is deposited directly on to the stainless-steel coin cell base, restricted to the inner diameter of thin Kapton ring. Glass fiber is used as separator between the stainless-steel substrate and the LCO cathode. Here, larger capacities were applied (e.g., 4 mAh/cm²) to observe capacity fade over time in addition to the influence of a full spectrum of electrolyte products formed throughout a wider voltage range (as compared to the narrower reduction range applied in the Li-metal 0.08 mAh/cm² experiments). The capacity of 4 mAh/cm² was chosen as the applied area capacity as it exceeds the approximately 3 mAh/cm² used in Li-ion batteries today.

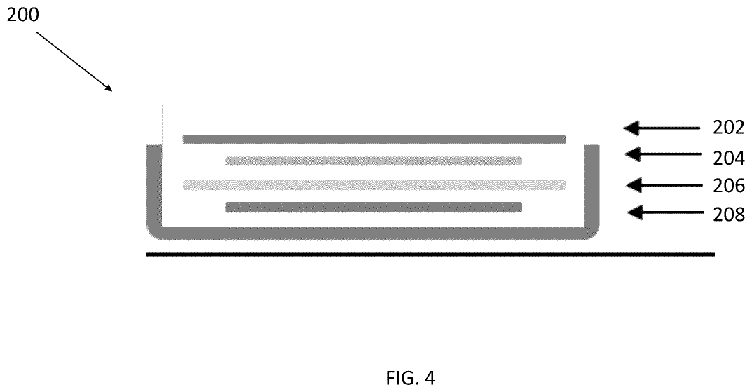

To probe the stability of the OS₃/FEC solvent system in the high areal capacity anodeless configuration, the solvent system was compared against EC/DMC using 1M LiTFSI salt. Table 7 depicts the first cycle irreversible loss of electrolyte compositions. FIG. 4 depicts the discharge capacity retention from cycle 1 using standard electrolyte composition 1M LiPF₆ EC/DMC and optimized solvent substituted compositions in anodeless cells at 4 mAh/cm². As depicted in Table 7, the new solvent substitution yielded significantly improved first cycle efficiencies (4.49% and 39.69% irreversible loss for 1M LiTFSI 90/10 OS₃/FEC and 1M LiTFSI EC/DMC, respectively).

TABLE 7

| Composition | % Irreversible loss |
|---|---|
| 1M LiPF₆ EC/DMC | 17.40 |
| 1M LiPF₆ 90/10 | 3.65 |
| OS3/FEC | |
| 1M LiTFSI EC/DMC | 39.69 |
| 1M LiTFSI 90/10 | 4.49 |
| OS3/FEC | |

Improvement was also observed to 20 cycles, as depicted in FIG. 4, where the OS₃/FEC substituted composition retained greater than 50% discharge capacity (vs approximately 30% discharge capacity retention for the EC/DMC substituted composition). This effect on the discharge capacity was also observed, although to a lesser degree, using 1M LiPF₆ salt with the same solvent substitutions. Here, the OS₃/FEC substituted composition is improved as compared to the EC/DMC composition in terms of irreversible loss but shows similar performance in later cycles.

### Example 8: Effect of Common Lithium Salts in OS₃/FEC Solvent System

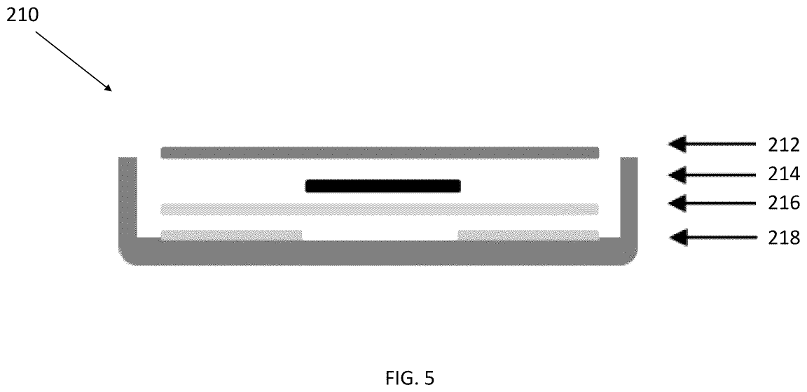

As the OS₃/FEC solvent system has been shown in the previous section to yield low first cycle losses and stable capacity retention to 20 cycles using LiTFSI, the properties of the solvent were further probed using other commonly utilized lithium salts. LiTFSI was substituted for LiBF₄, LiPF₆, and LiFSI and compared to the composition previously optimized using SEI observation experiments (0.6M LiTFSI 0.4M LDFOB 90/10). Table 8 depicts first cycle irreversible loss of the electrolyte compositions. FIG. 5 depicts discharge capacity retention from cycle 1 using lithium salt substitutions in the optimized OS₃/FEC solvent in anodeless cells at 4 mAh/cm².

TABLE 8

| Composition | % Irreversible loss |
|---|---|
| 0.6M LiTFSI 0.4M | 2.27 |
| LDFOB 90/10 OS3/FEC | |
| 0.6M LiBF₄ 0.4M | 4.79 |
| LDFOB 90/10 OS3/FEC | |
| 0.6M LiPF₆ 0.4M | 2.12 |
| LDFOB 90/10 OS3/FEC | |
| 0.6M LiFSI 0.4M | 2.26 |
| LDFOB 90/10 OS3/FEC | |

As depicted in Table 8 and FIG. 5, LDFOB is shown to be highly beneficial in conjunction with LiFSI or LiTFSI salts. Further, LiBF₄ was found to be detrimental in this system, having the lowest initial cycle loss, and much degradation with cycle number.

### Example 9: Effect of OS₃/FEC Solvent Ratio in LiTFSI and LDFOB Salt System

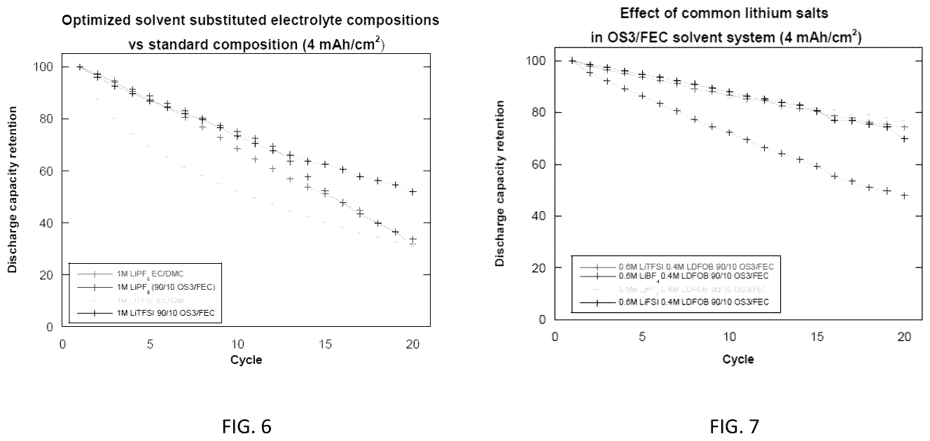

As discussed in the previous section, FEC enables the stabilization of the fluororganosiyl. The OS₃/FEC solvent system was optimized using the salt system 0.6M LiTFSI 0.4M LDFOB. OS₃ is shown to be a robust solvent, where FEC is an effective enabler for improved capacity retention and reduction of first cycle losses through the stabilization of the SEI film and subsequent decomposition of the OS₃ solvent. Table 9 depicts first cycle irreversible loss of electrolyte compositions. FIG. 6 depicts discharge capacity retention from cycle 1 using the lithium salt system 0.6M LiTFSI 0.4M LDFOB with varied OS₃/FEC solvent ratio in anodeless cells at 4 mAh/cm². As can be seen in Table 9 and FIG. 6, omitting FEC from the solvent results in the immediate and continuous decomposition of the electrolyte and poor performance whereas only 2% is highly effective to stabilize the system yielding an irreversible loss <3% and high cycling efficiencies. From this round of optimization, excess FEC was found to be detrimental and 8-10% proves to be most beneficial.

TABLE 9

| Composition | % Irreversible loss |
|---|---|
| 0.6M LiTFSI 0.4M | 99.93 |
| LDFOB 100/0 OS3/FEC | |
| 0.6M LiTFSI 0.4M | 2.70 |
| LDFOB 95/5 OS3/FEC | |
| 0.6M LiTFSI 0.4M | 2.25 |
| LDFOB 98/2 OS3/FEC | |
| 0.6M LiTFSI 0.4M | 2.27 |
| LDFOB 90/10 OS3/FEC | |
| 0.6M LiTFSI 0.4M | 2.42 |
| LDFOB 50/50 OS3/FEC | |

### Example 10: Impact of LiTFSI and LDFOB Salt Ratio in Optimized OS₃/FEC Solvent System

Having isolated the interaction between LDFOB concentration and the optimized solvent 90/10 OS₃/FEC, the interaction between LDFOB and LiTFSI were probed. Table 10 depicts first cycle irreversible loss of electrolyte compositions. FIG. 7 depicts discharge capacity retention from cycle 1 using LiTFSI and LDFOB salt substitutions in the optimized OS₃/FEC solvent in anodeless cells at 4 mAh/cm². As depicted in Table 10 and FIG. 7, in varying the LDFOB and LITFSI concentration as shown, first cycle irreversible losses differ by less than 1% between compositions. While concentrations exceeding 0.4M LDFOB slightly diminish benefits to first cycle loss, above 0.2M is necessary to achieve high efficiency to cycle 20, when paired with LiTFSI. In comparing the single salt 1M LiTFSI composition with and without, as shown in Table 6, LDFOB, it is evident that a critical amount of LDFOB is needed to achieved high discharge capacity retention in the OS₃/FEC solvent system.

TABLE 10

| Composition | % Irreversible loss |
|---|---|
| 1M LiTFSI 0.4M | 2.38 |
| LDFOB 90/10 OS3/FEC | |
| 0.8M LiTFSI 0.2M | 2.01 |
| LDFOB 90/10 OS3/FEC | |
| 0.4M LiTFSI 0.6M | 2.98 |
| LDFOB 90/10 OS3/FEC | |
| 0.2M LiTFSI 0.8M | 3.01 |
| LDFOB 90/10 OS3/FEC | |
| 0.3M LiTFSI 0.4M LiTFSI | 2.31 |
| 0.4M LDFOB 90/10 | |
| 0.6M LiTFSI 0.4M | 2.27 |
| LDFOB 90/10 OS3/FEC | |

### Example 11: Impact of LiFSI and LDFOB Salt Ratio in Optimized OS₃/FEC Solvent System

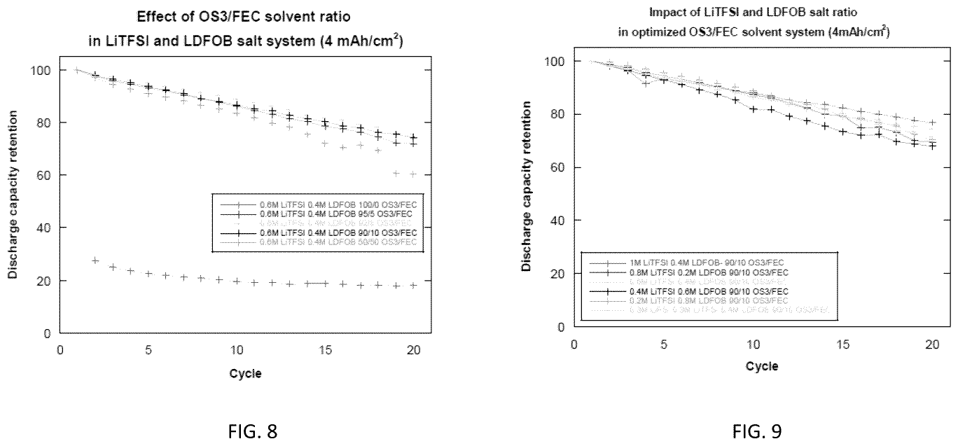

As shown above, LiFSI salt is beneficial in the tri-salt system with 90/10 OS₃/FEC. The interaction between LiFSI and LDFOB in this system were probed further by varying the LiFSI concentration. Table 11 depicts first cycle irreversible loss of the electrolyte compositions. FIG. 8 depicts dscharge capacity retention from cycle 1 using LiFSI salt substitutions in the optimized OS₃/FEC solvent in anodeless cells at 4 mAh/cm². As depicted in Table 11 and FIG. 8, LiFSI is shown to be a successful substitution for LiTFSI in the optimized 0.6M LiTFSI 0.4M LDFOB 90/10 OS₃/FEC composition, however concentrations exceeding 1M are detrimental in this system.

TABLE 11

| Composition | % Irreversible loss |
|---|---|
| 1M LiTFSI 0.4M LDFOB | 7.31 |
| 90/10 OS3/FEC | |
| 1.2M LiTFSI 0.4M LDFOB | 90.92 |
| 90/10 OS3/FEC | |
| 0.6M LiTFSI 0.4M LDFOB | 2.26 |
| 90/10 OS3/FEC | |

### Example 12: Capacity Fade of Benchmark and Optimized Compositions at 2.5 mAh/Cm² and 6.5 mAh/Cm²

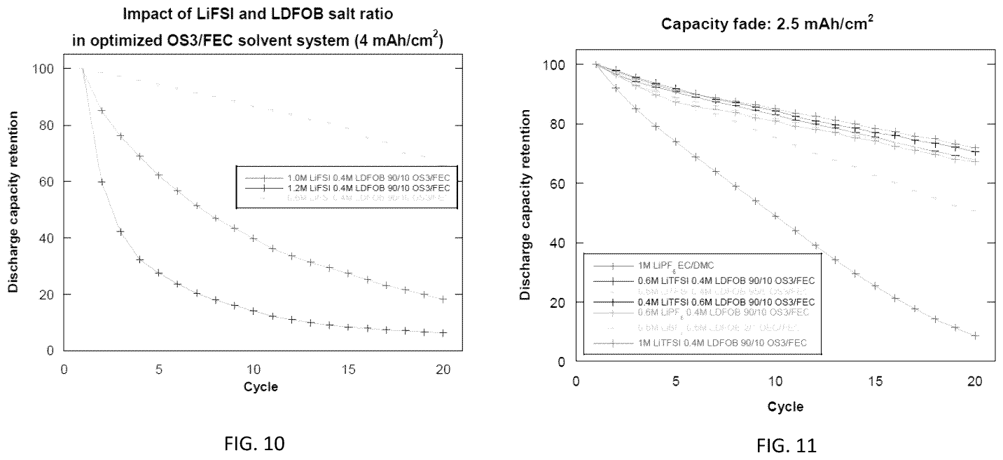

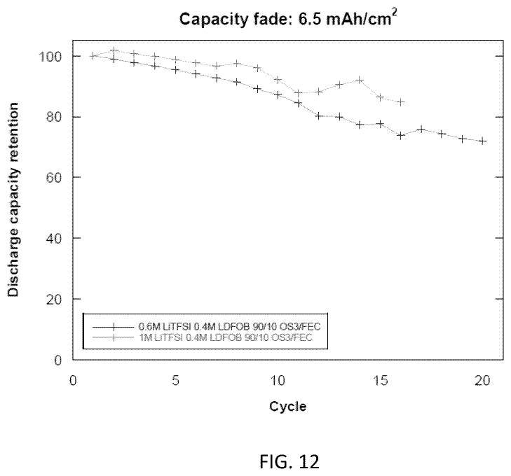

At lower plating capacities (2.5 mAh/cm²), where irreversible losses are generally expected to be higher, similar trends were found to exist for optimized salts and solvent systems as well as the more ubiquitous benchmark compositions (1M LiPF₆ EC/DMC) and those in literature (0.6M LiBF₄ 0.6M LDFOB 2/1 DEC/FEC), as depicted in Table 12 and FIG. 9. Extremely high plating capacities were also investigated to test the limitations of optimized electrolyte compositions (6.5 mAh/cm²), as depicted in Table 13 and FIG. 10. At lower plating capacities, the LiTFSI/LDFOB as well as the OS₃/FEC relationships identified in the previous sections prove to be robust, and optimized electrolyte compositions (0.6M LiTFSI 0.4M LDFOB 90/10 OS₃/FEC and 1M LiTFSI 0.4M LDFOB 90/10 OS₃/FEC) show similar trends to 4 mAh/cm² plating experiments. At higher plating capacities (6.5 mAh/cm²), first cycle losses are only slightly improved, indicating the robustness of first cycle efficiencies for these optimized compositions.

TABLE 12

| Composition | % Irreversible loss |
|---|---|
| 1M LiPF₆ EC/DMC | 33.63 |
| 0.6M LiTFSI 0.4M | 3.58 |
| LDFOB 90/10 OS3/FEC | |
| 0.4M LiTFSI 0.6M | 3.72 |
| LDFOB 95/5 OS3/FEC | |
| 0.6M LiTFSI 0.6M | 3.86 |
| LDFOB 90/10 OS3/FEC | |
| 0.6M LiPF₆ 0.4M LDFOB | 3.38 |
| 90/10 OS3/FEC | |
| 0.6M LiBF₄ 0.6M LDFOB | 5.11 |
| 2/1 DEC/FEC | |
| 1M LiTFSI 0.4M LDFOB | 2.79 |
| 90/10 OS3/FEC | |

Further embodiments of the present disclosure can be found in attached Appendix A, which is incorporated by reference herein.

The aforementioned examples are, of course, illustrative and not restrictive.

While a number of embodiments of the present disclosure have been describe, it is understood that these embodiments are illustrative only, and not restrictive, and that many modifications may become apparent to those of ordinary skill in the art. Further still, the various steps may be carried out in any desired order (and any desired steps may be added and/or any desired steps may be eliminated).

What is claimed is:

1. A battery comprising:
a positive current collector;
a positive electrode;
an electrolyte;
wherein the electrolyte comprises a solvent;
wherein the solvent comprises at least one of fluorinated organosilicon and lithium metal; and
a metal current collector;
wherein the metal current collector comprises lithium,
wherein the lithium is plated on the metal current collector;
wherein a layer is coated over the lithium plated metal current collector;
wherein the layer comprises at least nitrogen and fluorine.

2. The battery of claim 1, wherein the battery is a lithium metal battery.

3. The battery of claim 1, wherein the battery is a metal battery comprising at least one of Si, Ge, AL, Ga, Bi, Ag, Sn or Au.

4. The battery of claim 1, wherein the fluorinated organosilicon is fluoroethylene.

5. The battery of claim 1, wherein the layer is less than 1000 nm thick.

6. The battery of claim 1, wherein the layer is less than 500 nm thick.

7. The battery of claim 1, wherein the layer comprises silicon.

8. The battery of claim 1, wherein a ratio of fluorinate to organosilicon in the fluorinated organosilicon is 2:1 to 30:1.

9. The battery of claim 1, wherein the solvent has a concentration is greater than 20% by volume of the electrolyte.

10. A battery comprising:
a positive current collector;
a positive electrode;
an electrolyte;
wherein the electrolyte comprises a solvent;
wherein the solvent comprises at least one of fluorinated organosilicon or lithium metal;
a metal current collector;
wherein the metal current collector consists essentially of no lithium metal.

11. The battery of claim 10, wherein the battery is a lithium metal battery.

12. The battery of claim 10, wherein the battery is a metal battery comprising at least one of Si, Ge, AL, Ga, Bi, Ag, Sn or Au.

13. The battery of claim 10, wherein the fluorinated organosilicon is fluoroethylene.

14. The battery of claim 10, wherein a ratio of fluorinate to organosilicon in the fluorinated organosilicon is 2:1 to 30:1.

15. The battery of claim 10, wherein the solvent has a concentration is greater than 20% by volume of the electrolyte.

16. A method of forming a lithium battery, comprising:
obtaining a battery;
wherein the battery comprises:
a positive current collector;
a positive electrode;
an electrolyte;
wherein the electrolyte comprises a solvent,
wherein the solvent comprises at least one of fluorinated organosilicon or lithium metal; and
a metal current collector;
wherein the metal current collector consists essentially of no lithium metal;
applying a current in a range of 0.1 to 20 mAh/cm² to the metal current collector; and
forming a coated lithium plating on the metal current collector;
wherein the coated lithium plating comprises a coating layer comprising at least nitrogen and fluorine.

17. The battery of claim 16, wherein the fluorinated organosilicon is fluoroethylene.

18. The battery of claim 16, wherein the layer is less than 1000 nm thick.

19. The battery of claim 16, wherein the layer is less than 500 nm thick.

20. The battery of claim 16, wherein the layer comprises silicon.
